(19) United States
(12) Patent Application Publication
(10) Pub. No.: US 2015/0186065 A1
(43) Pub. Date: Jul. 2, 2015

(54) MEMORY SYSTEM AND BAD BLOCK MANAGEMENT METHOD

(71) Applicant: SAMSUNG ELECTRONICS CO., LTD., Suwon-Si (KR)

(72) Inventor: DONG-YOUNG SEO, Hwaseong-si (KR)

(21) Appl. No.: 14/659,250

(22) Filed: Mar. 16, 2015

Related U.S. Application Data
(63) Continuation of application No. 13/438,203, filed on Apr. 3, 2012, now abandoned.

(30) Foreign Application Priority Data
May 3, 2011 (KR) 10-2011-0042096

(51) Int. Cl. G06F 3/06

(52) U.S. Cl. CPC G06F 3/0619; G06F 3/0688; G06F 3/065; G06F 3/0652; G06F 3/064

(57) ABSTRACT

Disclosed is a bad block management method of a memory system that includes virtual blocks having a plurality of units and at least one reserved block. The bad block management method includes mapping the virtual blocks and the at least one reserved block onto one physical block in the plurality of physical blocks, determining that a first virtual block in the virtual blocks includes a bad virtual block unit, and replacing the bad virtual block unit in the first virtual block with a first reserved block unit selected from the reserved block units.

### CROSS-REFERENCE TO RELATED APPLICATIONS

This application is a Continuation of U.S. application Ser. No. 13/438,203, filed Apr. 3, 2012, which claims the benefits under 35 U.S.C. §119 of Korean Patent Application No. 10-2011-0042096 filed May 3, 2011, the subject matter of which is hereby incorporated by reference.

### BACKGROUND OF THE INVENTION

Embodiments of the inventive concept relate to memory systems and bad memory block management methods used within memory systems.

Semiconductor memory devices may be classified as volatile and nonvolatile in their operative nature. Volatile memory devices lose stored data in the absence of applied power, and include the static RAM (SRAM), dynamic RAM (DRAM), synchronous DRAM (SDRAM), and the like. Nonvolatile memory devices are able to retain stored data in the absence of power, and include the read only memory (ROM), programmable ROM (PROM), electrically programmable ROM (EPROM), electrically erasable and programmable ROM (EEPROM), flash memory device, phase-change RAM (PRAM), magnetic RAM (MRAM), resistive RAM (RRAM), ferroelectric RAM (FRAM), and the like. Flash memory devices may be further classified as NOR type and NAND type.

Many contemporary semiconductor memory devices include one or more three-dimensional (3D) memory cell arrays. Such 3D memory cell arrays dramatically increase the per unit of area integration density of constituent memory cells within semiconductor memory devices.

### SUMMARY OF THE INVENTION

In one aspect, embodiments of the inventive concept are directed to a bad block management method for a memory device of a memory system, wherein the memory device includes a memory cell array divided into a plurality of physical blocks accessed by a plurality of logical blocks, each logical block including virtual blocks and at least one reserved block, each virtual block including corresponding virtual block units, and the at least one reserved block including corresponding reserved block units. The method comprises; mapping the virtual blocks and the at least one reserved block onto one physical block in the plurality of physical blocks, determining that a first virtual block in the virtual blocks includes a bad virtual block unit, and replacing the bad virtual block unit in the first virtual block with a first reserved block unit selected from the reserved block units.

In another aspect, embodiments of the inventive concept are directed to a bad block management method for a memory device of a memory system, wherein the memory device includes a memory cell array divided into a plurality of physical blocks accessed by a plurality of logical blocks, each logical block including virtual blocks and reserved blocks, each virtual block including corresponding virtual block units, and each reserved block including corresponding reserved block units, the method comprising; mapping the virtual blocks and the reserved blocks onto one physical block in the plurality of physical blocks, determining that a first virtual block in the virtual blocks includes a bad virtual block unit, and replacing the bad virtual block unit in the first virtual block with a first reserved block unit selected from a first reserved block in the reserved blocks.

In other aspects, embodiments of the inventive concept are directed to memory devices and memory systems capable of operating in a manner that effectively enables the foregoing bad block management methods.

### BRIEF DESCRIPTION OF THE DRAWINGS

The above and other objects and features will become apparent from the following description made with reference to the accompanying drawings.

FIG. 1 is a block diagram illustrating a memory system according to an embodiment of the inventive concept.

FIG. 2 is a diagram illustrating a memory block including sub blocks according to an embodiment of the inventive concept.

FIG. 3 is a diagram illustrating a memory block having sub blocks illustrated in FIG. 1 according to another embodiment of the inventive concept.

FIG. 4 is a diagram for describing a mapping method between a logical block and a physical block in a memory system according to an embodiment of the inventive concept.

FIG. 5 is a diagram for describing a bad block managing method according to an embodiment of the inventive concept.

FIG. 6 is a diagram for describing a bad block managing method after erasing of a first virtual block under a condition in FIG. 5.

FIG. 7 is a diagram for describing a bad block management method according to another embodiment of the inventive concept.

FIG. 8 is a diagram illustrating a bad block management method after a first virtual block VB1 and a reserved block RB in FIG. 7 are replaced.

FIG. 9 is a diagram for describing a bad block management method according to still another embodiment of the inventive concept.

FIG. 10 is a diagram illustrating logical blocks for describing iterative updating of a unit of a virtual block.

FIG. 11 is a diagram illustrating a bad block management method when a first unit illustrated in FIG. 10 is updated.

FIG. 12 is a diagram illustrating a bad block management method when a first unit illustrated in FIG. 11 is updated.

FIG. 13 is a diagram illustrating a bad block management method when a first unit illustrated in FIG. 12 is updated.

FIG. 14 is a diagram illustrating conversion to addresses of a physical block from addresses of a virtual block when a bad block management method according to an embodiment of the inventive concept is used.

FIG. 15 is a block diagram illustrating a memory card according to an exemplary embodiment of the inventive concept.

FIG. 16 is a block diagram illustrating a moviNAND according to an embodiment of the inventive concept.

FIG. 17 is a block diagram of an SSD according to an embodiment of the inventive concept.

FIG. 18 is a block diagram of a computing system including an SSD in FIG. 17 according to an embodiment of the inventive concept.

FIG. 19 is a block diagram of an electronic device including an SSD in FIG. 17 according to an embodiment of the inventive concept.

FIG. 20 is a block diagram of a server system including an SSD in FIG. 17 according to an embodiment of the inventive concept.

FIG. 21 is a block diagram illustrating a PPN device according to an embodiment of the inventive concept.

FIG. 22 is a diagram showing a handheld electronic device according to an embodiment of the inventive concept.

### DETAILED DESCRIPTION

Embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Through the written description and drawings, like reference numbers and labels are used to denote like or similar elements.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

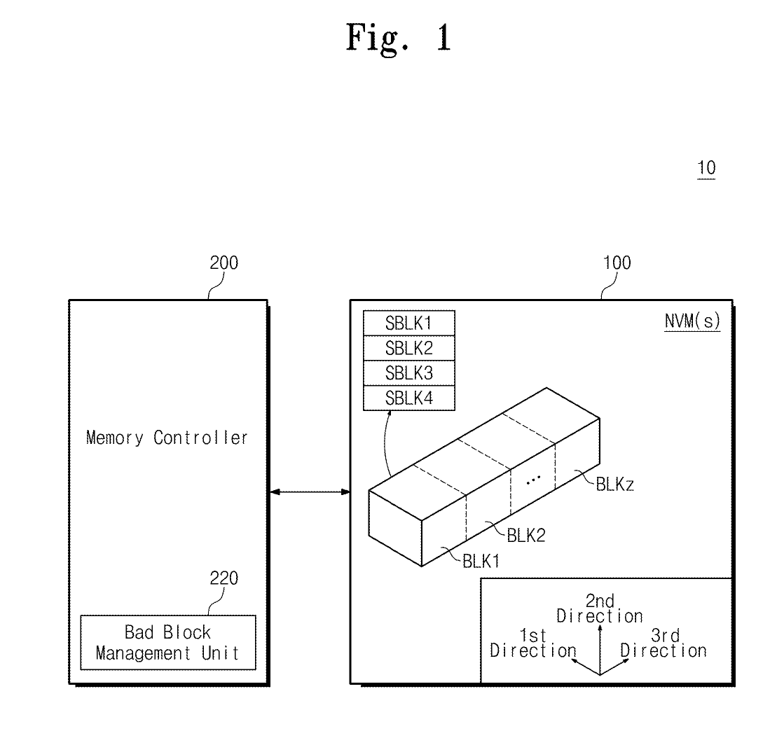

Figure (FIG. 1 is a block diagram illustrating a memory system according to an embodiment of the inventive concept. Referring to FIG. 1, an exemplary memory system 10 comprises at least one nonvolatile memory device 100 and a memory controller 200 configured to control the operation of the nonvolatile memory device 100.

The nonvolatile memory device 100 according may be a NAND flash memory, a vertical NAND flash memory, a NOR flash memory, a Resistive Random Access Memory (RRAM), a Phase-change RAM (PRAM), a Magnetroresistive RAM (MRAM), a Ferroelectric RAM (FRAM), a Spin Transfer Torque RAM (STT-RAM), or the like. Further, in certain embodiments of the inventive concept, the nonvolatile memory device 100 will be implemented with a three-dimensional (3D) (or vertically stacked) memory cell array structure. In certain embodiments of the inventive concept, the nonvolatile memory device will be a flash memory device in which a charge storage layer is formed by a conductive floating gate. In other embodiments, the nonvolatile memory device will be a charge trap flash (CTF) memory in which a charge storage layer is formed of an insulation film. For convenience of consistent description, the description that follows assumes that nonvolatile memory device 100 is a vertical NAND flash memory device (VNAND).

As conceptually illustrated in FIG. 1, the nonvolatile memory device 100 will typically include a plurality of memory blocks BLK1 to BLKz arranged in an arbitrary direction and in relation to the principle surface of a constituent substrate. In FIG. 1, three (3) mutually orthogonal layout directions (i.e., first, second and third directions) are assumed as references.

Each one of the plurality of memory blocks BLK1 to BLKz typically comprises a plurality of sub blocks SBLK1 to SBLK4. The sub blocks SBLK1 to SBLK4 may be differentiated in their operative nature according to the structure and/or physical disposition within the constituent block. That is, the sub blocks SBLK1 to SBLK4 may have different structural properties and/or different electrical properties.

In FIG. 1, there is exemplarily illustrated an example in which each memory block comprises four (4) sub blocks. However, it will be under understood by those skilled in the art that any reasonable number of sub blocks may be used in the definition of a block.

Each of the memory blocks BLK1 to BLKz generally includes a plurality of pages, each of which includes a plurality of memory cells connected to a common word line. Each memory cell may be connected with a corresponding bit line and configured to store one or more data bits. Possible memory blocks (e.g., memory blocks BLK1 to BLKz) that may be incorporated within certain embodiments of the inventive concept are illustrated, for example, in published U.S. Patent Applications: 2009/0310415, 2010/0078701, 2010/0117141, 2010/0140685, 2010/02135527, 2010/0224929, 2010/0315875, 2010/0322000, 2011/0013458, and 2011/0018036, the collective subject matter of which is hereby incorporated by reference.

In various embodiments of the inventive concept, the nonvolatile memory device 100 may perform erase operations on a block by block basis, and/or on a sub block by sub block basis.

The memory controller 200 may be configured to control the input and/or output of data (hereafter, singularly or collectively, “input/output” or “I/O”) to the memory device 100 in response to a request (i.e., a command, a command packet, an instruction, or set of control signals) received from an external host. The control and/or I/O functionality of the memory controller 200 may implemented using hardware, software, firmware, or a combination thereof.

In certain embodiments of the inventive concept, the memory controller 200 comprises a bad block management unit 220 configured to manage the inevitable presence of one or more “bad” memory block(s) and/or sub block(s). A bad memory block is a particular memory block that is functionally impaired in its ability to store data, correctly provide previously stored data, and/or effectively interoperate within the memory device 100 or the memory controller 200. In certain embodiments, the bad block management unit 220 may be configured to manage bad memory blocks within the plurality of memory blocks BLK1 to BLKz within the nonvolatile memory device 100 on a sub block by sub block basis. Although not specifically illustrated in FIG. 1 but as will be conventionally understood, the memory controller 200 may include a processing unit, a buffer memory, a randomizer circuit, an ECC circuit, a host interface, a nonvolatile memory interface, etc.

The nonvolatile memory device 100 and the memory controller 200 may be implemented on a single semiconductor chip and/or on a common substrate. For example, one possible memory system 10 that is consistent with certain embodiments of the inventive concept is disclosed in published U.S. Patent Application 2010/0082890, the subject matter of which is hereby incorporated by reference.

When the memory system 10 of FIG. 1 is configured to manage bad blocks on a sub block basis, the conventionally understood process of “garbage collection” may be more effectively accomplished across the plurality of memory blocks BLK1 to BLKz, or within a particular memory block. In this context, the process of garbage collection may be termed a valid data copy operation.

In one approach adaptable to the memory system 10, bad block management may be accomplished in relation to noted error characteristic(s) wherein a sub block. Accordingly, each one of the relatively large memory blocks BLK1 to BLKz need not be designated as a bad block when only small number of errors are identified in one or more sub blocks. In other words, the functional replacement of errantly operating “blocks” may be made on a sub block by sub block basis, rather than a whole memory block basis. As a result, the memory system 10 may be defined with a reduced number of “reserve” blocks (i.e., memory blocks provided to replace identified bad bocks).

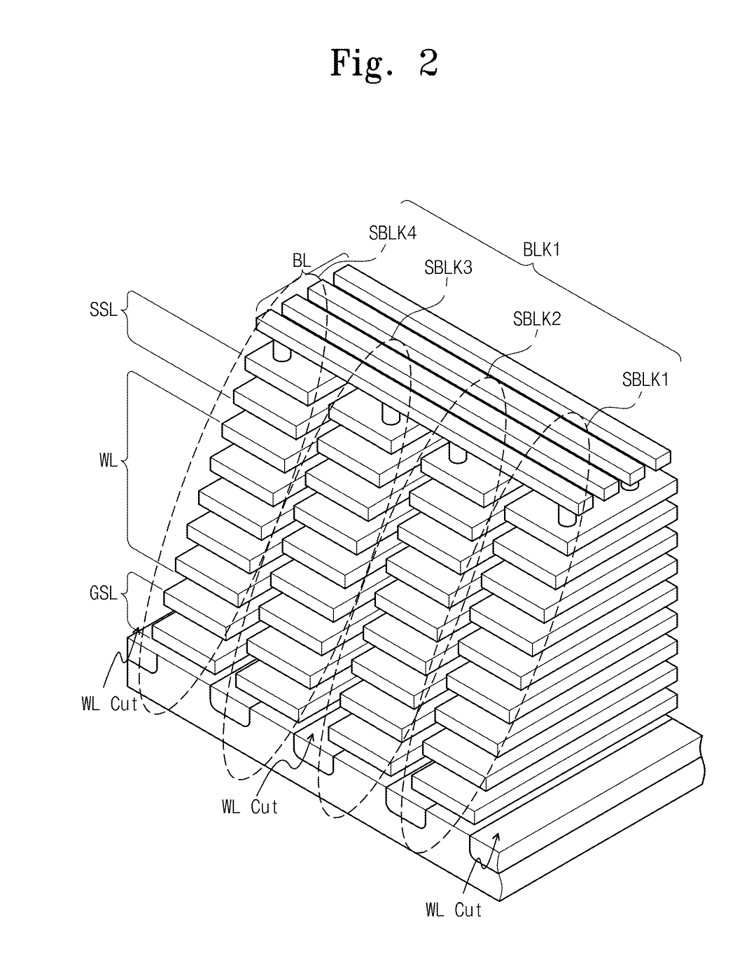

FIG. 2 is a diagram further illustrating one memory block (e.g., BLK1) of the 3D memory device 100 of FIG. 1 including a plurality of sub blocks according to an embodiment of the inventive concept. Referring to FIG. 2, four (4) vertical sub blocks SBLK1 to SBLK4 are designated within the vertical memory block BLK1. In this context, those skilled in the art will recognize that the term “vertical” is used to denote a 3D memory array structure in which a plurality of material layers implementing memory cells are vertically disposed (or stacked) one on top of the other on a common substrate. Each of the sub blocks SBLK1 to SBLK4 is vertically configured between at least one ground selection line GSL and at least one string selection line SSL and includes a plurality of successively stacked word lines WL. Each of the sub blocks SBLK1 to SBLK4 is separated from adjacent sub blocks by one or more word line cuts WL Cut. Although not illustrated in FIG. 2, each of the word line cuts WL Cut may include a common source line CSL, wherein the common source lines included in the word line cuts WL Cut may be interconnected.

By this configuration, a plurality of vertical “pillars” may be formed on the substrate that extend from at least one ground selection line GSL through the plurality of word lines WL to reach at least one string selection line SSL. As a result in the illustrated example of FIG. 2, the least one ground selection line GSL, the plurality of word lines WL, and the at least one string selection line SSL have a plate shape within a particular sub block pillar. Hence, each vertical sub block pillar, as such, includes an upper surface connected with one or more bit lines BL and a lower surface connected to the common source line CSL.

Those skilled in the art will recognize from the foregoing an equivalent circuit for the memory block BLK1. That is, each vertical string may be disposed between a bit line and a common source line CSL. A bit line may correspond to a conductive material extending in the third direction. A string selection transistor for each vertical string may be connected with a corresponding bit line. The gate of the string selection transistor may be connected with the string selection line SSL. A ground selection transistor for each vertical string may be connected with the common source line CSL. The gate of the ground selection transistor may be connected with a ground selection line GSL. In each vertical string, memory cell transistors (or, memory cells) may be formed between the string and ground selection transistors. The respective gates of the memory cell transistors may be connected with a corresponding word line WL.

In this manner, vertical memory cell “strings” may be defined by row and column units. Strings commonly connected to a bit line may form a column. A string connected with the string selection line SSL may form a row.

A “height” may be defined for each vertical string. In each vertical string, the relative height of any particular memory cell may be given. For example, the height of a first memory cell vertically adjacent to the ground selection transistor may designated as 1, and so forth.

Vertical strings of the same row may share a string selection line. Different rows of vertical strings may be connected with different string selection lines. In the same row of vertical strings, memory cells having the same height may share a word line. At the same height, word lines of different rows of vertical strings may be connected in common. Word lines may be connected at a layer where conductive materials extending in a first direction are provided. The conductive materials extending in the first direction may be interconnected via contacts at an upper layer.

The same row of vertical strings may share a ground selection line GSL. Different rows of vertical strings may be connected with different ground selection lines. That is, vertical strings may be connected with a ground selection line GSL in common.

As illustrated in FIG. 2, word lines having the same height within the vertical memory block BLK1 may be connected in common. Accordingly, when a word line is selected, all vertical strings connected with the selected word line may be selected. Different rows of vertical strings may be connected with different string selection lines. A row of vertical strings may be selected by selecting at least one string selection line. Further, a selected row of vertical strings may be selected by row units by selecting bit lines.

Certain memory blocks consistent with other embodiments of the inventive concept may be implemented with a so-called “merged” word line structure. That is, two word lines may be merged to form a merged word line structure.

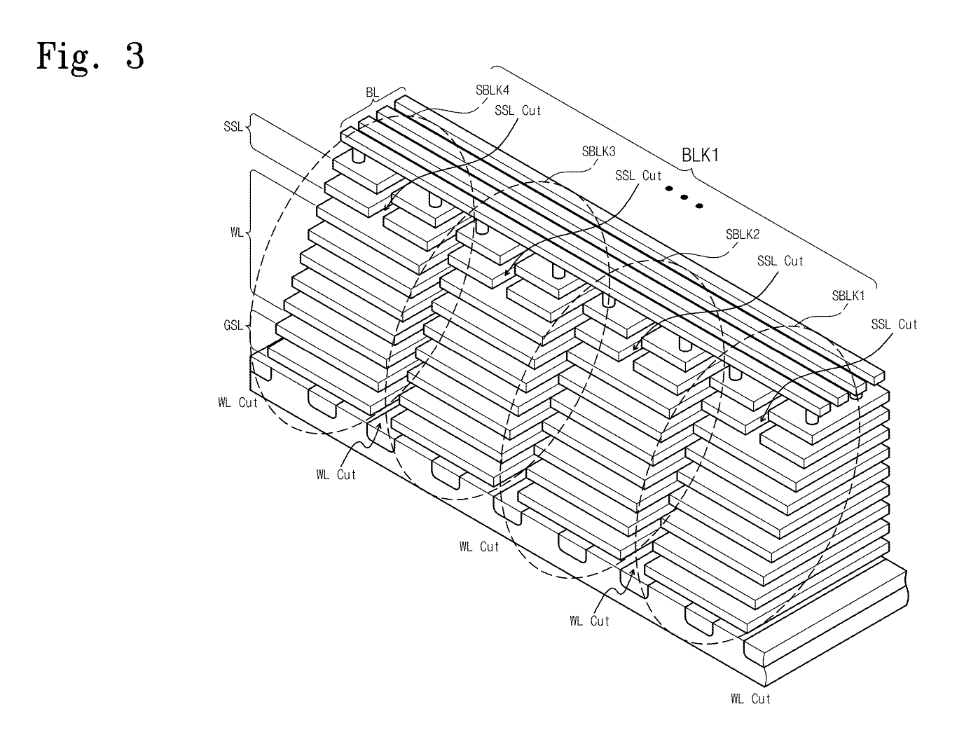

FIG. 3 is a diagram illustrating a memory block having sub blocks according to another embodiment of the inventive concept. Referring to FIG. 3, four (4) sub blocks SBLK1 to SBLK4 are again formed on a substrate. Each of the sub blocks SBLK1 to SBLK4 is again formed by stacking at least one ground selection line GSL, a plurality of word lines WL, and at least one string selection line SSL between word line cuts WL Cut. The at least one string selection line SSL may be separated by a string selection line cut. Although not illustrated in FIG. 3, each of the word line cuts WL Cut may include a common source line CSL. Common source lines included in the word line cuts WL Cut may be interconnected.

In FIG. 3, the structure between word line cuts may designated as a sub block. However, the inventive concept is not limited to only this structure, and those skilled in the art will understood that a structure between a word line cut and a string selection line cut may be used as a sub block.

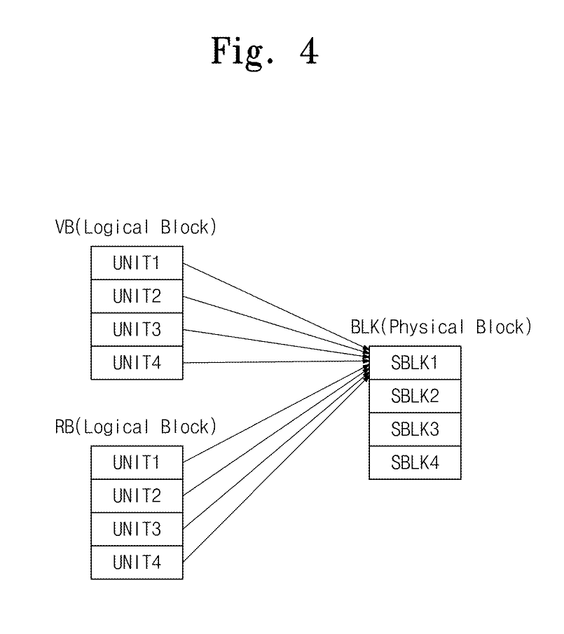

FIG. 4 is a conceptual diagram describing one possible mapping method between logical blocks and corresponding physical blocks in a memory system according to an embodiment of the inventive concept. Referring to FIG. 4, a logical block may include a virtual block VB and a reserved block RB. The virtual block VB may be a logical block used to store data, and the reserved block RB may be a logical block used to manage a bad unit. Herein, the bad unit may be a unit within a defined plurality of units UNIT1 to UNIT4 that has previously been identified as “bad”, according to given definition standards. In the illustrated example, each of the virtual and reserved blocks VB and RB include four (4) units UNIT1 to UNIT4, but this is just one selected example.

Each of the logical block units UNIT1 to UNIT4 may be mapped onto any one of sub blocks SBLK1 to SBLK4 of the physical block BLK. As illustrated in FIG. 4, one of the units UNIT1 to UNIT4 of the virtual block VB or one of the units UNIT1 to UNIT4 of the reserved block RB may be mapped onto a first sub block BLK1 of the physical block BLK.

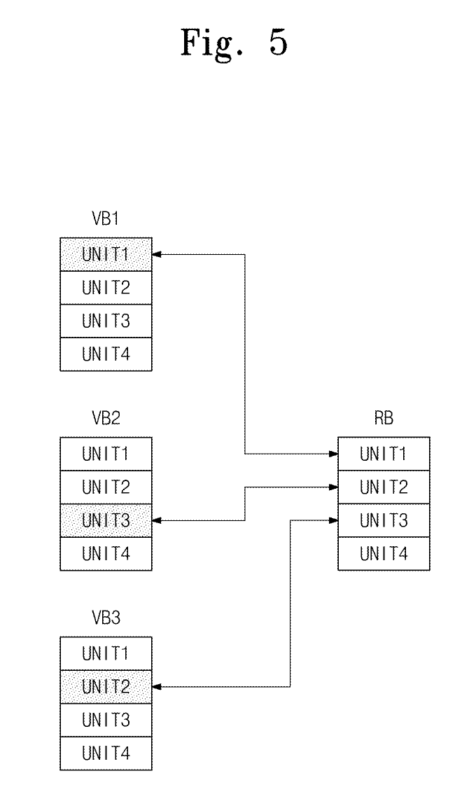

FIG. 5 is a conceptual diagram further describing a bad block management method according to an embodiment of the inventive concept. Referring to FIG. 5, logical blocks are assumed to include three (3) virtual blocks VB1, VB2, and VB3 and a reserved block RB. In FIG. 5, it is assumed that a first unit UNIT1 of a virtual block VB1, a third unit UNIT3 of a virtual block VB2, and a second unit UNIT2 of a virtual block VB3 have errors. At this time, a bad block management unit 220 in FIG. 1 may assign a first unit UNIT1 of the reserved block RB as a “replacement region” for the first unit UNIT1 of the virtual block VB1, a second unit UNIT2 of the reserved block RB as a replacement region for the third unit UNIT3 of the virtual block VB2, and a third unit UNIT3 of the reserved block RB as a replacement region for the second unit UNIT2 of the virtual block VB3.

In this manner, embodiments of the inventive concept are able to efficiently replace multiple errant units (or portions) identified within a logical block using only a single reserve block designated within the logical block, and then use the single reserve block to make needed replacements within a physical block (or sub block) corresponding to the logical block.

The execution of certain operations by memory device 100 will now be described with the foregoing approach in mind. First, it is assumed that the nonvolatile memory device 100 of FIG. 1 performs an erase operation on a block basis with the replacements described in relation to FIG. 5 in place. Since the erase operation is performed “by the block”, additional management on the designated reserved block must be made, albeit such management is performed on a sub block basis following the erase operation.

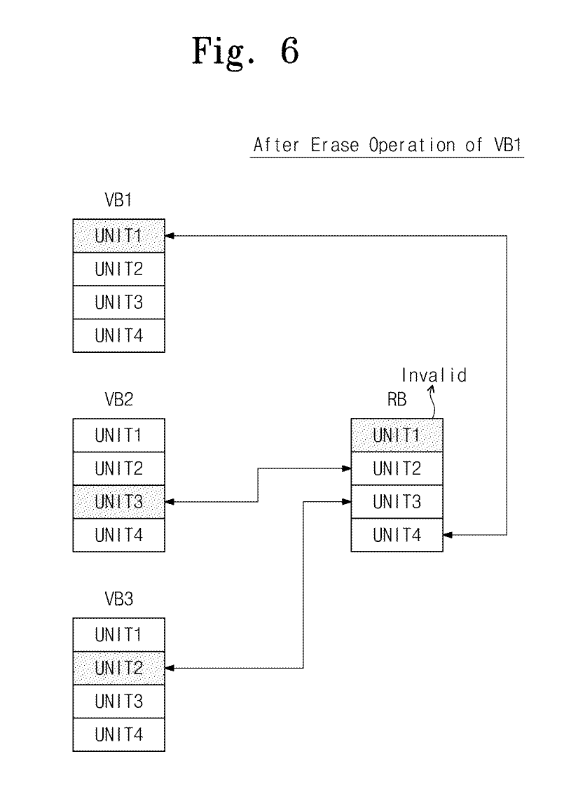

FIG. 6 is another conceptual diagram describing a bad block managing method after execution of an erase operation on a virtual block assuming the conditions described in relation to FIG. 5. During the erase operation of a first virtual block VB1, data has been previously stored in first to third units UNIT1 to UNIT3 of a reserved block RB. For this reason, it is impossible to erase the reserved block RB. As illustrated in FIG. 6, a fourth unit UNIT4 being a “free” region of the reserved block RB may be assigned as a replacement region for the first unit UNIT1 of the first virtual block VB1. Update may be made to indicate that the first unit UNIT1 of the reserved block RB now stores invalid data. Accordingly, the re-mapping of the first virtual block VB1 may be made.

As will be seen hereafter, the bad block management method according to certain embodiments of the inventive concept will minimize the costs associated with the erase operation directed to a virtual block as it effects the reserved block.

Returning to FIGS. 5 and 6, if any unit of a virtual block is “erroneous” (i.e., is associated with error-producing (or “errant”) physical memory cells), it may be replaced by designating a corresponding unit of a reserved block. There are several ways to do this.

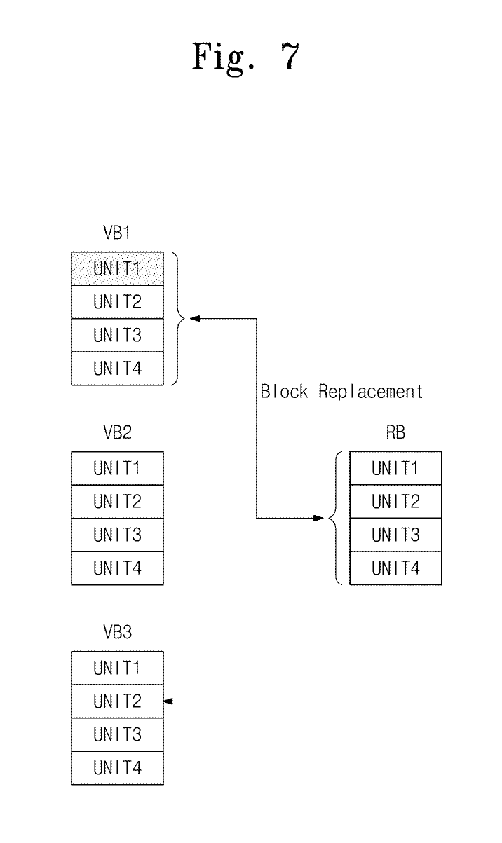

FIG. 7 is a conceptual diagram describing a bad block management method according to an embodiment of the inventive concept. Referring to FIG. 7, a logical block includes three (3) virtual blocks VB1, VB2, and VB3 and a reserved block RB. It is further assumed that the first unit UNIT1 of a first virtual block VB1 is erroneous. Hence, when the first unit UNIT1 of the first virtual block VB1 is determined to be a bad unit, the bad block management unit 220 of FIG. 1 may be used to replace the entire first virtual block VB1 with the entire reserved block RB. That is, the first virtual block VB1 essentially becomes the reserved block RB, and the reserved block RB (without an erroneous unit) becomes the first virtual block VB1. However, using this approach, the “new” reserved block RB (once the first virtual block VB1 including the erroneous UNIT 1) may not be used as a replacement for a subsequently identified bad unit. Hence, the “cost” of using the bad block management method described in relation to FIG. 7 is a re-mapping of the entire reserved block RB when the first virtual block VB1 is replaced.

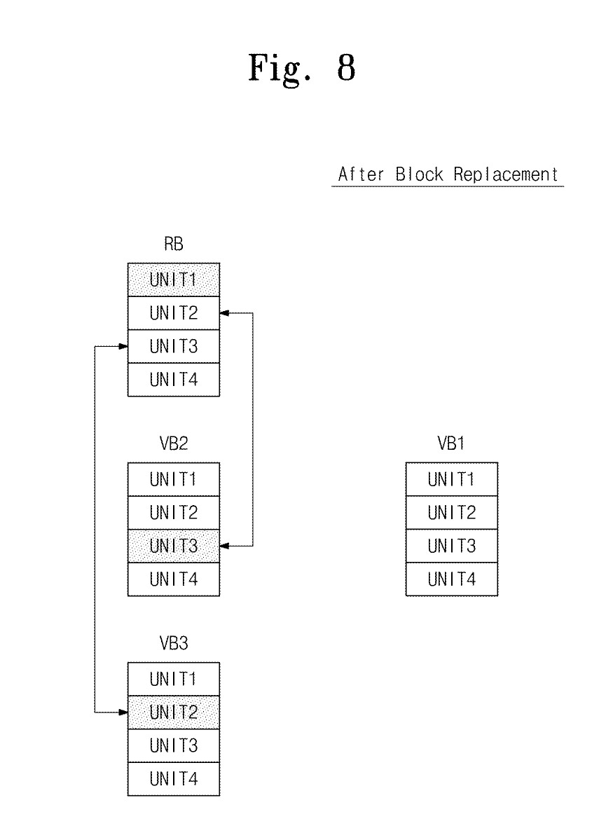

FIG. 8 is another conceptual diagram illustrating a bad block management method that assumes the conditions following the replacement of the first virtual block VB1 with the reserved block RB as described in relation to FIG. 7. It is now further assumed that the third unit UNIT3 of the second virtual block VB2 and the second unit UNIT2 of the third virtual block VB3 are identified as bad units. Further, it is assumed that the reserved block previously provided to replace the virtual blocks VB2 and VB3, each now including a bad unit, no longer exists, having been swapped for the first virtual block VB1.

In this case, the bad block management unit 220 of FIG. 1 may be used to assign the second unit UNIT2 of the reserved block RB as a replacement region for the third unit UNIT3 of the second virtual block VB2 and the third unit UNIT3 of the reserved block RB as a replacement region for the second unit UNIT2 of the third virtual block VB3. It should be noted that the first unit UNIT1 of the reserved block RB is a known bad unit at this point in time.

Referring to FIGS. 7 and 8, before a replacement unit for a bad unit of a virtual block is assigned from a reserved block, it must first be determined whether or not the reserved block exists as an “error-free” reserved block (i.e., one having no units previously designated as erroneous), or whether one or more erroneous units is present within the reserved block. If an error-free reserved block exists, a virtual block including a bad unit may be swapped for the error-free reserved block on a block basis. However, if no error-free reserved block exists, a bad unit within a virtual block may be replaced with a specific non-erroneous unit from the “non-error-free” reserved block on a unit basis.

With this type of bad block management method, embodiments of the inventive concept may operate with a lower overall re-mapping cost associated with the use of one or more reserved block(s) RB. That is, the relatively higher re-mapping costs associated with a unit by unit accounting for bad units within a virtual block need only be generated once all reserved block(s) RB have previously been swapped on a block (or sub block) basis. The foregoing method takes into account an ability to replace respective bad unit(s) within one or more virtual block(s) using a unit by unit replacement from a common reserved block, wherein any given reserved block is associated with a single physical block.

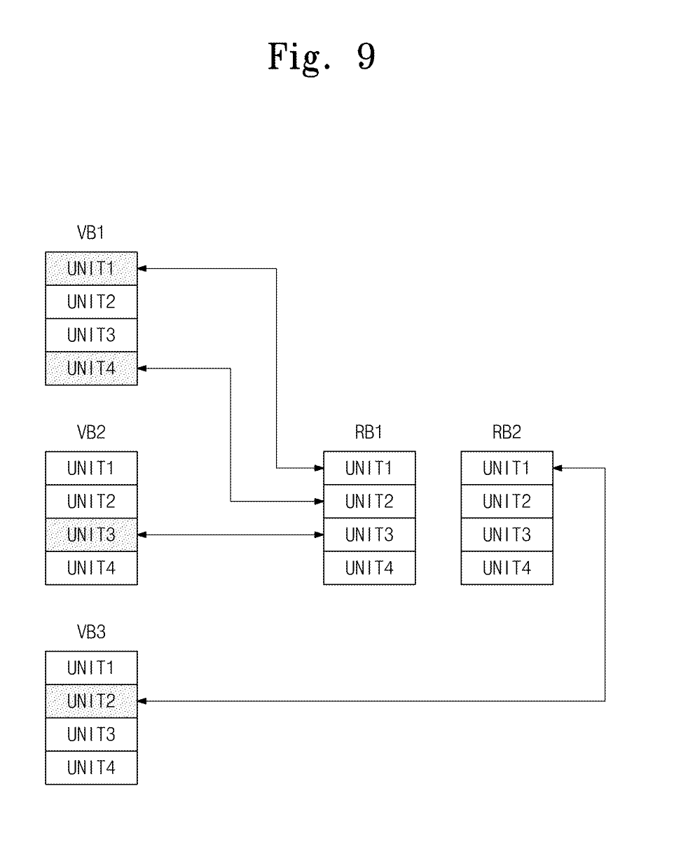

FIG. 9 is yet another conceptual diagram describing a bad block management method according to embodiment of the inventive concept. Referring to FIG. 9, an exemplary logical block selected from a plurality of logical blocks of a memory system includes three (s) virtual blocks VB1, VB2, and VB3 and two (2) reserved blocks RB1 and RB2.

In FIG. 9, it is further assumed that the first and fourth units UNIT1 and UNIT4 of the first virtual block VB1, the third unit UNIT3 of the second virtual block VB2, and the second unit UNIT2 of the third virtual block VB3 are bad units. In this case, the bad block management unit 220 of FIG. 1 may be used to effectively substitute (e.g., using an assignment technique) the first unit UNIT1 of a first reserved block RB1 for the first unit UNIT1 of the first virtual block VB1, the second unit UNIT2 of the first reserved block RB1 for the fourth unit UNIT4 of the first virtual block VB1, the third unit UNIT3 of the first reserved block RB1 for the third unit UNIT3 of the second virtual block VB2, and the first unit UNIT1 of a second reserved block RB2 for the third unit UNIT3 of the third virtual block VB3.

Within this approach, the fourth unit UNIT4 of the first reserved block RB1 will not be assigned as a replacement region for a unit of the third virtual block VB3. Instead, it will be left available for assignment as a replacement region for a further bad unit identified in the first and second virtual blocks VB1 and VB2, or for some additional update associated with a unit in the first and second virtual blocks VB1 and VB2. Stated in other terms, if a number of “available” unit(s) (i.e., not yet assigned units) in a reserved block falls below a defined reference number, following an assignment of a unit in the reserved block to replace a bad unit, no further units from the reserved block may be assigned unless certain conditions are met.

With the bad block management method consistent with certain embodiments of the inventive concept, replacement regions for bad units in different virtual blocks may be assigned from the same reserved block, so long as defined assignment conditions are met.

Upon mapping (or re-mapping) of the reserved block, bad units included in the same virtual block may be mapped onto units of the same reserved block. In the event that replacement units corresponding to a virtual block are invalidated at the same time, units of a reserved block mapped onto the virtual block may be invalidated simultaneously. Accordingly, the process by which blocks (or sub blocks) are invalidated may be performed more efficiently. As a result, block erase operations may be made without the prior necessity of executing a garbage collection operation associated with the invalidation of the block.

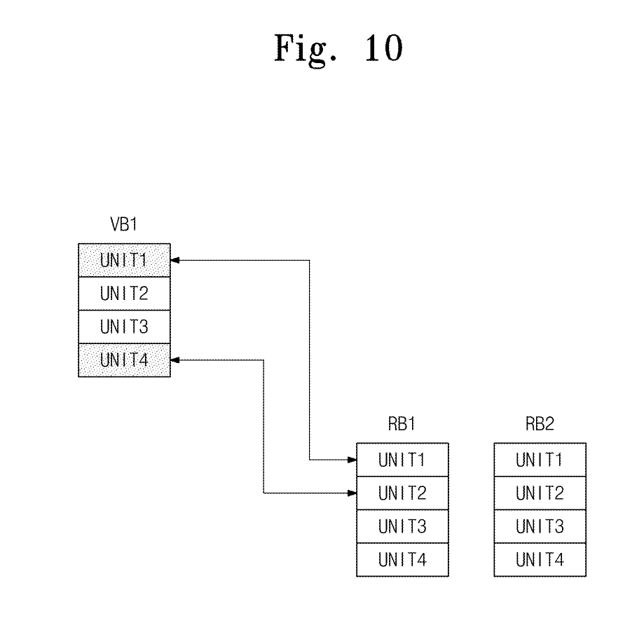

In FIGS. 10 through 13 variously describe bad block management method(s) according to embodiments of the inventive concept that incorporate iterative update of a unit in a virtual block.

FIG. 10 is a conceptual diagram illustrating a logical block undergoing iterative update of a unit. Referring to FIG. 10, the logical block includes a virtual block VB1 and two (2) reserved blocks RB1 and RB2. It is assumed that first and fourth units UNIT1 and UNIT4 of the virtual block VB1 are bad units. In this case, the bad bock management unit 220 of FIG. 1 may assign a first unit UNIT1 of the first reserved block RB1 as a replacement region for the first unit UNIT1 of the virtual block VB1, and a second unit UNIT2 of the first reserved block RB1 as a replacement region for the fourth unit UNIT4 of the virtual block VB1.

As before, a memory system according to embodiments of the inventive concept may effectively reduce the replacement cost associated with bad unit management by appropriate use (and re-use) of replacement units provided by the reserved block. In one aspect, such memory systems may gather virtual blocks having a similar update period in a replacement block (i.e., a reserved block), and/or utilize a format such as a log unit upon assigning of a replacement unit.

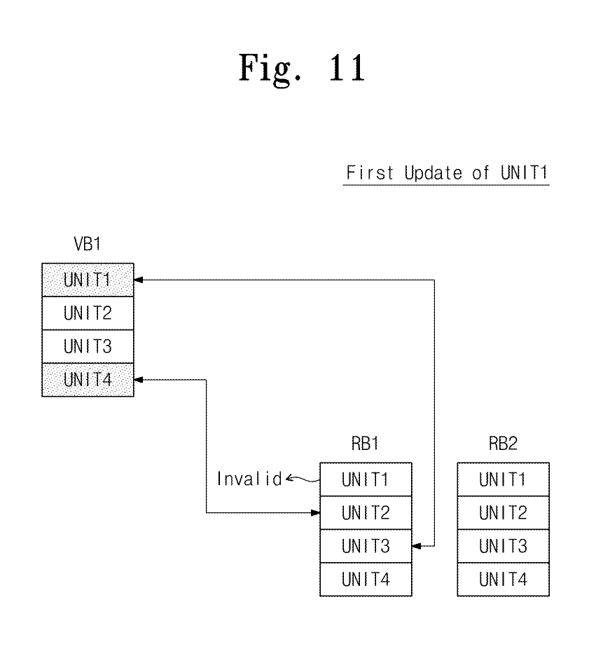

FIG. 11 is a conceptual diagram further illustrating the bad block management method when the first unit of FIG. 10 is one-time updated. Referring to FIG. 11, the bad block management unit 220 of FIG. 1 assigns a third unit UNIT3 of a first reserved block RB1 as a replacement region for the first unit UNIT1 of a virtual block VB1 upon update, and the first unit UNIT1 of the first reserved block RB1 is designated as invalid data.

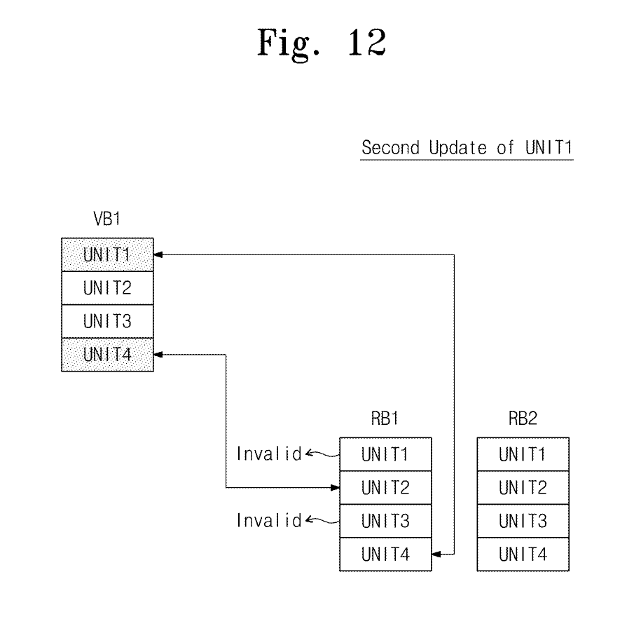

FIG. 12 is a conceptual diagram further illustrating the bad block management method when the first unit of FIGS. 10 and 11 is two-times updated. Referring to FIG. 12, the bad block management unit 220 of FIG. 1 assigns the fourth unit UNIT4 of a first reserved block RB1 as the replacement region for the first unit UNIT1 of a virtual block VB1, and the third unit UNIT3 of the first reserved block RB1 (like the first unit UNIT1) is additionally designated as invalid data.

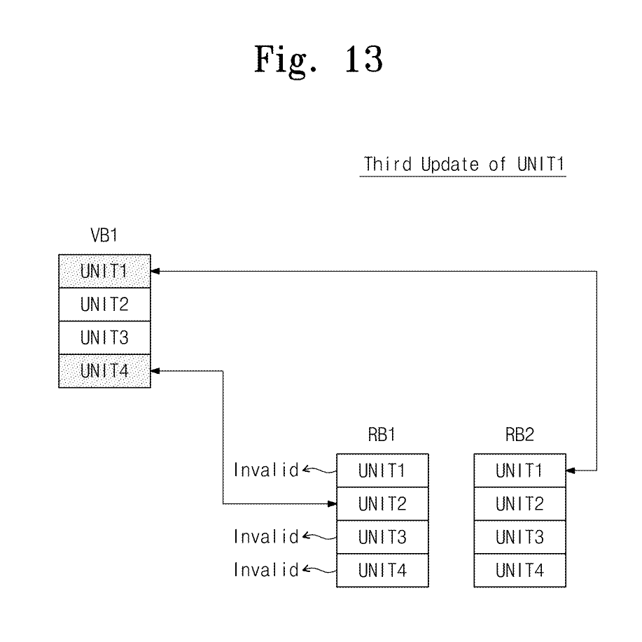

FIG. 13 is a conceptual diagram further illustrating the bad block management method when the first unit of FIGS. 10, 11 and 12 is three-times updated. Referring to FIG. 13, the bad block management unit 220 of FIG. 1 assigns the first unit UNIT1 of the second reserved block RB2 as a replacement region for the first unit UNIT1 of the virtual block VB1, and the fourth unit UNIT4 of the first reserved block RB1 (like the first unit UNIT1 and the third unit UNIT3) is additionally designated as invalid data.

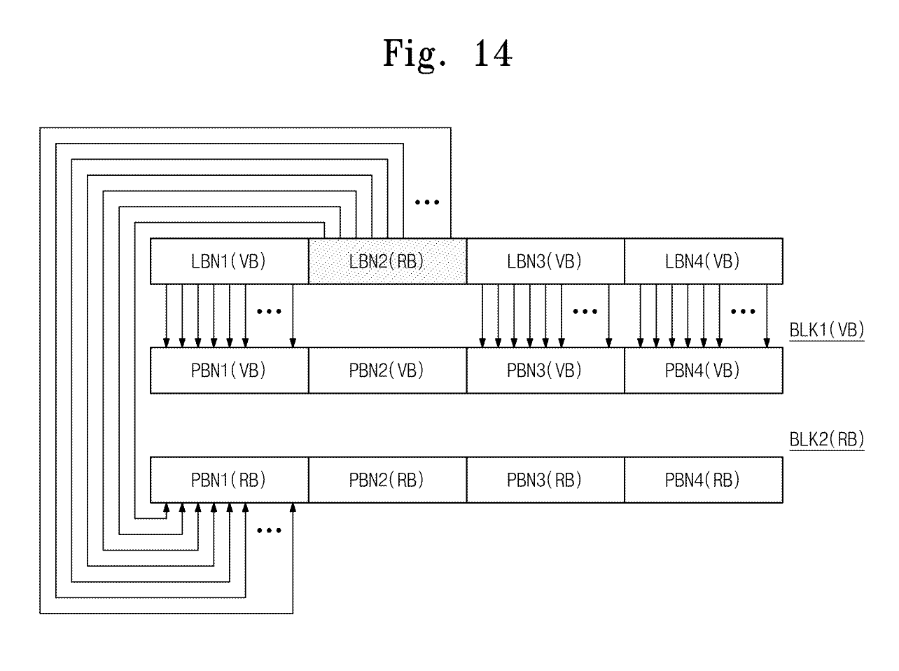

FIG. 14 is a conceptual diagram an address conversion approach for a physical block associated with a virtual block in accordance with a bad block management method consistent with an embodiment of the inventive concept. Below, it is assumed that the second unit UNIT2 of a virtual block VB is a bad unit and the first unit UNIT1 of the reserved block RB is assigned as a replacement region for the second unit UNIT2 of the virtual block VB. Referring to FIG. 14, a logical block is assumed to include first to fourth logical addresses LBN1 to LBN4, a first physical block BLK1 may be a physical block corresponding to a virtual block VB, and a second physical block BLK2 may be a physical block corresponding to a reserved block RB.

Herein, first logical addresses LBN1 may be logical addresses corresponding to a first unit UNIT1 of the virtual block VB, second logical addresses LBN2 may be logical addresses corresponding to a first unit UNIT1 of the reserved block RB, third logical addresses LBN3 may be logical addresses corresponding to a third unit UNIT3 of the virtual block VB, and fourth logical addresses LBN4 may be logical addresses corresponding to a fourth unit UNIT4 of the virtual block VB,

In the illustrated embodiment of FIG. 14, it is further assumed that the first to fourth logical addresses LBN1 to LBN4 may be sequentially assigned.

Referring to FIG. 14, the first logical addresses LBN1 may be translated into physical addresses PBN1 of a first sub block SBLK1 of a first physical block BLK1, the third logical addresses LBN3 may be translated into physical addresses PBN3 of a third sub block SBLK3 of the first physical block BLK1, and the fourth logical addresses LBN4 may be translated into physical addresses PBN4 of a fourth sub block SBLK4 of the first physical block BLK1. Further, the second logical addresses LBN2 may be translated into physical addresses PBN1 of a first sub block SBLK1 of a second physical block BLK2.

Hence, in the illustrated embodiment of FIG. 14, the physical addresses PBN1 to PBN4 of the first physical block BLK1 and the second physical block BLK2 may be sequentially assigned.

From the foregoing it may be understood that a memory system according to an embodiment of the inventive concept may manage a bad block on a sub block basis such that other non-bad portions (e.g., sub blocks or constituent memory units) of the same bad memory may still be used within the memory system. In a related aspect, memory systems according to embodiments of the inventive concept may assign bad units of a virtual block to units of a reserved block so that a memory block will be managed efficiently during an erase operation directed to the block unit. In another aspect, memory systems according to embodiments of the inventive concept may replace a bad virtual block with a reserved block so that a bad virtual block is recycled as a reserved block.

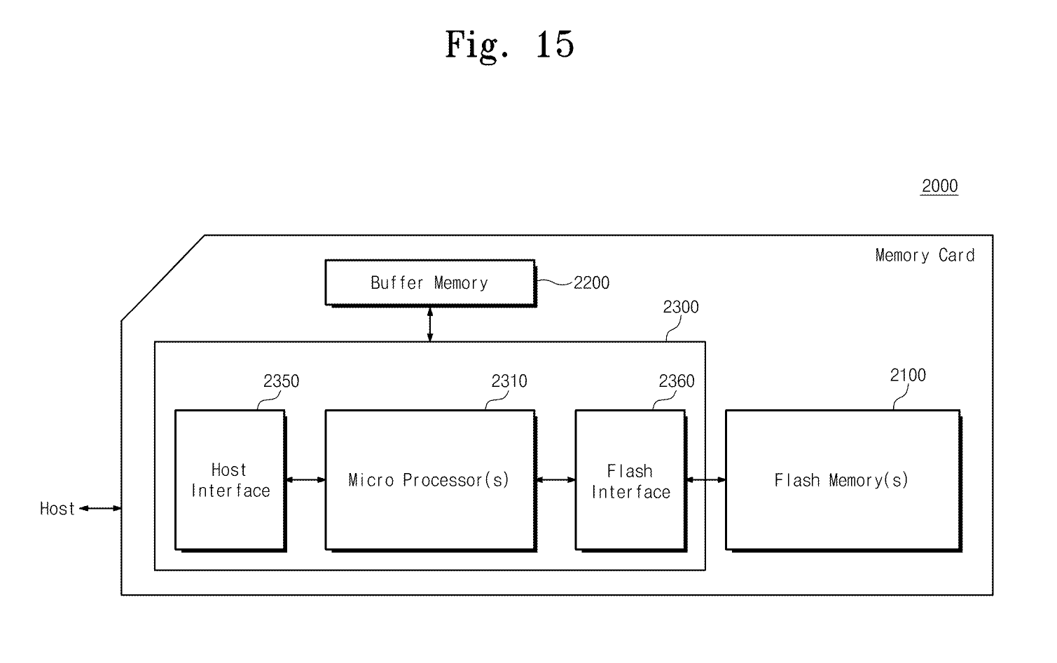

FIG. 15 is a block diagram illustrating a memory card according to an embodiment of the inventive concept. Referring to FIG. 15, a memory card 2000 may include at least one flash memory 2100, a buffer memory device 2200, and a memory controller 2300 for controlling the flash memory 2100 and the buffer memory device 2200.

The flash memory device 2100 may be implemented the same as a nonvolatile memory device 100 of FIG. 1. The buffer memory device 2200 may be used to temporarily store data generated during the operation of the memory card 2000. The buffer memory device 2200 may be implemented using a DRAM or an SRAM.

The memory controller 2300 may be connected between a host and the flash memory 2100. The memory controller 2300 may be configured to access the flash memory 2100 in response to a request from the host. The memory controller 2300 may be implemented the same as a memory controller 200 of FIG. 1.

The memory controller 2300 may include at least one microprocessor 2310, a host interface 2320, and a flash interface 2330. The microprocessor 2310 may be configured to drive firmware. The host interface 2320 may interface with the host via a card protocol (e.g., SD/MMC) for data exchanges between the host and the memory interface 2330.

The memory card 2000 may be applicable to Multimedia Cards (MMCs), Security Digitals (SDs), miniSDs, memory sticks, smartmedia, and transflash cards. Detailed description of the memory card 2000 is disclosed in U.S. Patent Publication No. 2010/0306583, the entirety of which is incorporated by reference herein.

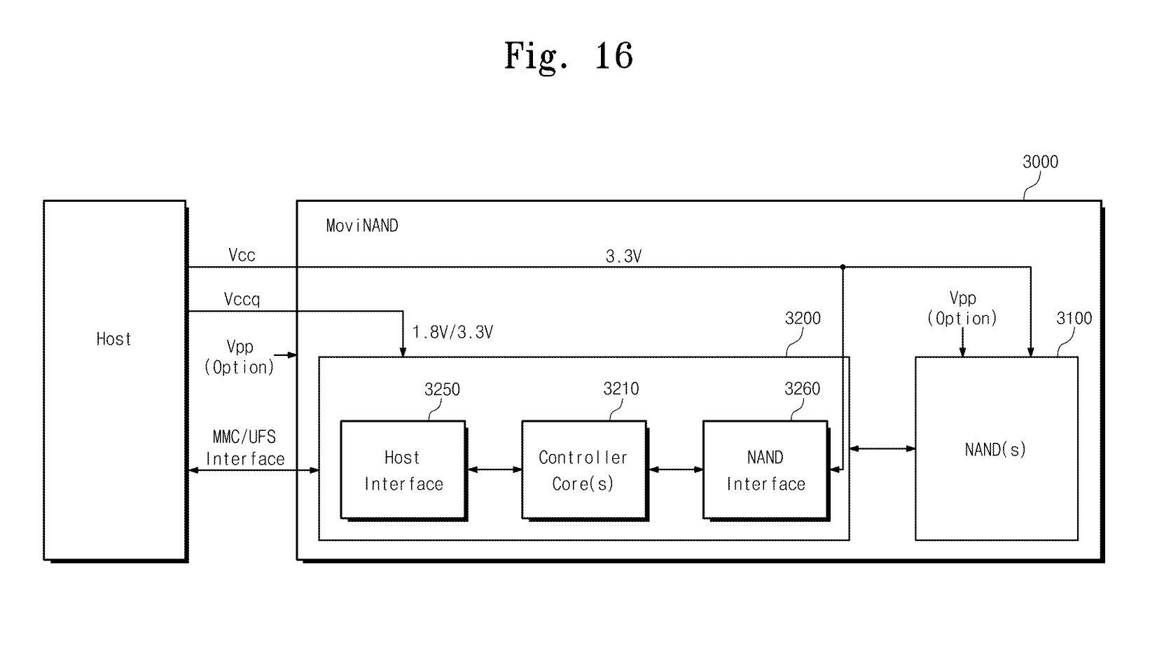

FIG. 16 is a block diagram illustrating a so-called “moviNAND” according to an embodiment of the inventive concept. Referring to FIG. 16, a moviNAND device 3000 may include at least one NAND flash memory device 3100 and a controller 3200. The moviNAND device 3000 may support the MMC 4.4 (called eMMC) standard. The moviNAND device 3000 may be implemented the same as a memory system 10 in FIG. 1.

The NAND flash memory device 3100 may be implemented the same as a nonvolatile memory device 100 in FIG. 1. In an embodiment, the NAND flash memory device 3100 may be a single data rate (SDR) NAND flash memory device or a double data rate (DDR) NAND flash memory device. In an embodiment, the NAND flash memory device 3100 may include NAND flash memory chips. Herein, the NAND flash memory device 3100 may be implemented by stacking the NAND flash memory chips at one package (e.g., FBGA, Fine-pitch Ball Grid Array, etc.).

The controller 3200 may be implemented the same as a memory controller 200 in FIG. 1. The controller 3200 may include at least one controller core 3210, a host interface 3250, and a NAND interface 3260. The controller core 3210 may control an overall operation of the moviNAND device 3000.

The host interface 3250 may be configured to perform an MMC interface between the controller 3210 and a host. The NAND interface 3260 may be configured to interface between the NAND flash memory device 3100 and the controller 3200. In an embodiment, the host interface 3250 may be a parallel interface (e.g., an MMC interface). In another embodiment, the host interface 3250 of the moviNAND device 3000 may be a serial interface (e.g., UHS-II, UFS, etc.).

The moviNAND device 3000 may receive power supply voltages Vcc and Vccq from the host. Herein, the power supply voltage Vcc (about 3V) may be supplied to the NAND flash memory device 3100 and the NAND interface 3250, while the power supply voltage Vccq (about 1.8V/3V) may be supplied to the controller 3200.

The moviNAND 3000 according to an exemplary embodiment of the inventive concept may be advantageous to store mass data as well as may have an improved read characteristic. The moviNAND 3000 according to an exemplary embodiment of the inventive concept is applicable to small and low-power mobile products (e.g., a Galaxy S, iPhone, etc).

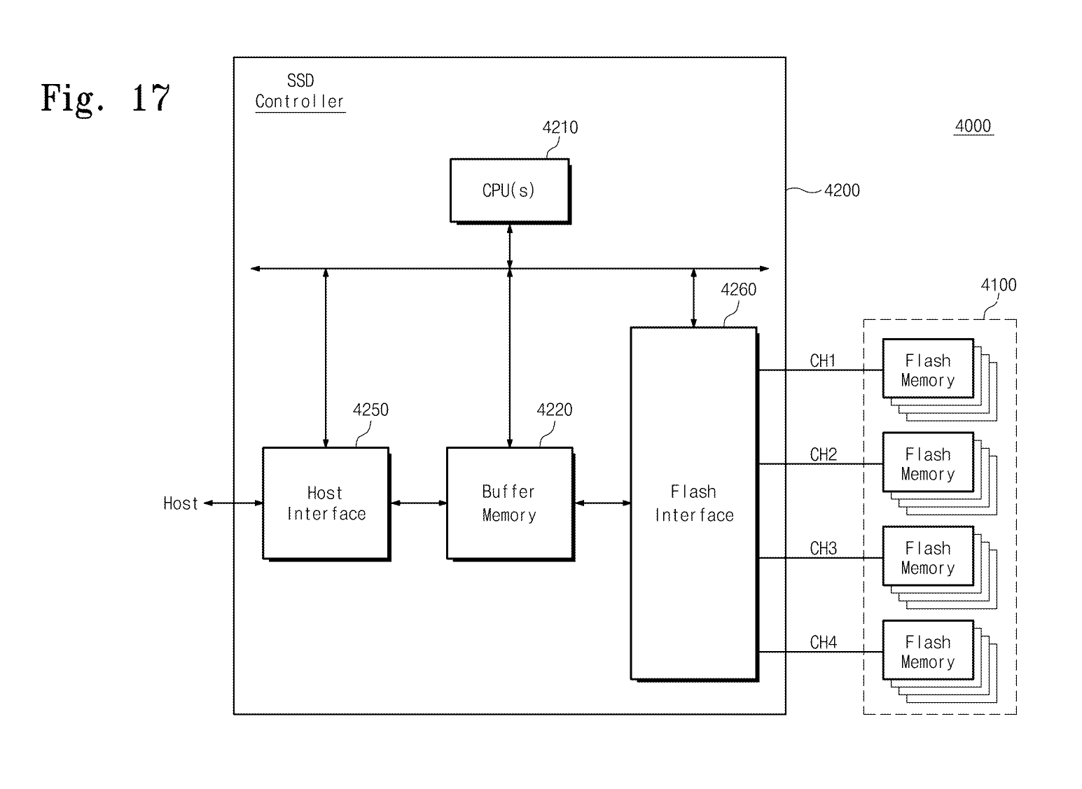

The inventive concept is applicable to a solid state drive (SSD). FIG. 17 is a block diagram of an SSD according to an embodiment of the inventive concept. Referring to FIG. 17, an SSD 4000 may include a plurality of flash memory devices 4100 and an SSD controller 4200.

Each of the flash memory devices 4100 may be implemented the same as a nonvolatile memory device 100 of FIG. 1.

The SSD controller 4200 may be implemented the same as a memory controller 200 in FIG. 1.

The SSD controller 4200 may control the plurality of flash memory devices 4100. The SSD controller 4200 may include at least one CPU 4210, a buffer memory 4220, a host interface 4250, and a flash interface 4260.

The buffer memory 4220 may temporarily store data transferred between an external device and the flash memory devices 4100. The buffer memory 4220 may be used to store programs to be executed by the CPU 4210. The buffer memory 4220 may be implemented using an SRAM. The buffer memory 4220 in FIG. 17 may be included within the SSD controller 4200. However, the inventive concept is not limited thereto. The buffer memory 4220 according to an exemplary embodiment of the inventive concept can be provided at an outside of the SSD controller 4200.

Under the control of the CPU 4210, the host interface 4250 may exchange data with a host through the communication protocol. The communication protocol may be the ATA protocol. The ATA protocol may include a Serial Advanced Technology Attachment (SATA) interface, a Parallel Advanced Technology Attachment (PATA) interface, an External SATA (ESATA) interface, etc. In another embodiment, the communication protocol may be the Universal Serial Bus (USB) protocol.

Data to be received or transmitted from or to the host through the host interface 4250 may be delivered through the buffer memory 4220 without passing through a CPU bus, under the control of the CPU 4210.

The flash interface 4260 may be configured to interface between the SSD controller 4200 and the flash memory devices 4100 that are used as storage devices. The flash interface 4260 may be configured to support NAND flash memories, One-NAND flash memories, multi-level flash memories, or single-level flash memories.

The SSD 4000 according to an exemplary embodiment of the inventive concept may improve the reliability of data by storing random data at a program operation. Accordingly, the reliability of data stored in the SSD 4000 may be improved. A detailed description of one possible embodiment of the SSD 4000 is provide within published U.S. Patent Application No. 2010/0082890, the subject matter of which is hereby incorporated by reference.

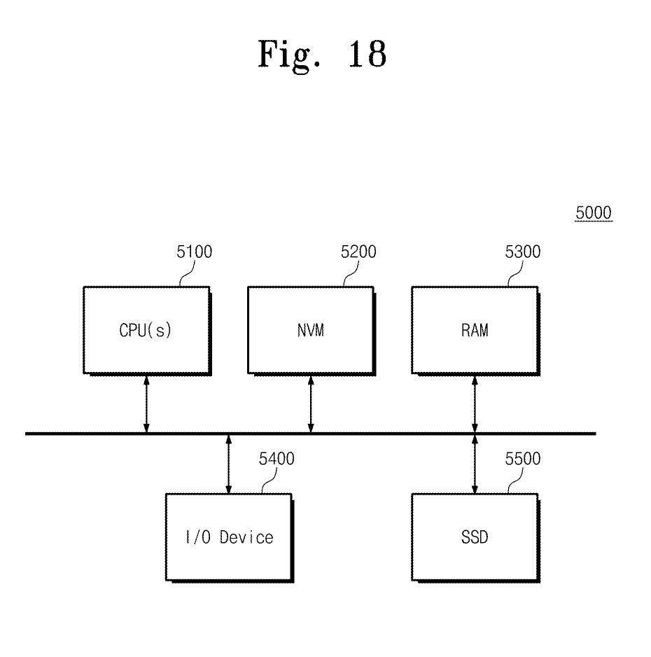

FIG. 18 is a block diagram of a computational system including the SSD 4000 of FIG. 17 according to an embodiment of the inventive concept. Referring to FIG. 18, a computational system 5000 may include at least one CPU 5100, a nonvolatile memory device 5200, a RAM 5300, an input/output (I/O) device 5400, and an SSD 5500.

The CPU 5100 may be connected to a system bus. The nonvolatile memory device 5200 may store data used to drive the computational system 5000. Herein, the data may include a start command sequence or a basic I/O system (BIOS) sequence. The RAM 5300 may temporarily store data generated during the execution of the CPU 5100.

The I/O device 5400 may be connected to the system bus through an I/O device interface such as keyboards, pointing devices (e.g., mouse), monitors, modems, and the like.

The SSD 5500 may be a readable storage device and may be implemented the same as the SSD 4000 of FIG. 17.

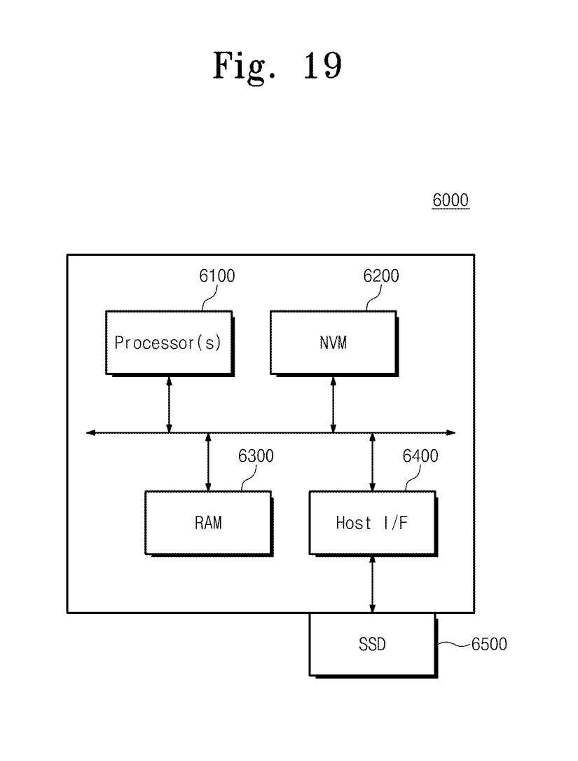

FIG. 19 is a block diagram of an electronic device including the SSD 4000 of FIG. 17 according to an embodiment of the inventive concept. Referring to FIG. 19, an electronic device 6000 may include a processor 6100, a ROM 6200, a RAM 6300, a flash interface 6400, and an SSD 6500.

The processor 6100 may access the RAM 6300 to execute firmware codes or other codes. Also, the processor 6100 may access the ROM 6200 to execute fixed command sequences such as a start command sequence and a basic I/O system (BIOS) sequence. The flash interface 6400 may be configured to interface between the electronic device 6000 and the SSD 6500

The SSD 6500 may be detachable from the electronic device 6000. The SSD 6500 may be implemented the same as the SSD 4000 of FIG. 17.

The electronic device 6000 may include cellular phones, personal digital assistants (PDAs), digital cameras, camcorders, portable audio players (e.g., MP3), and portable media players (PMPs).

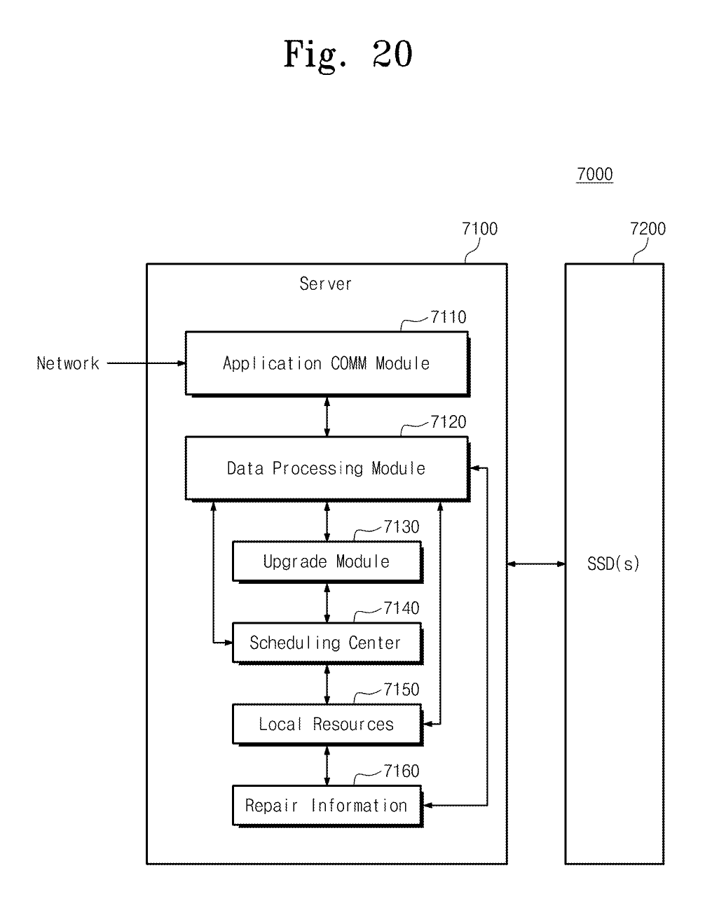

FIG. 20 is a block diagram of a server system including the SSD 4000 of FIG. 17 according to an embodiment of the inventive concept. Referring to FIG. 20, a server system 7000 may include a server 7100 and at least one SSD 7200 that stores data used to drive the server 7100. The SSD 7200 may be configured the same as an SSD 4000 of FIG. 17.

The server 7100 may include an application communication module 7110, a data processing module 7120, an upgrade module 7130, a scheduling center 7140, a local resource module 7150, and a repair information module 7160.

The application communication module 7110 may be configured to communicate with a computing system connected to a network and the server 7100, or to allow the server 7100 to communicate with the SSD 7200. The application communication module 7110 may transmit data or information, provided through a user interface, to the data processing module 7120.

The data processing module 7120 may be linked to the local resource module 7150. Here, the local resource module 7150 may provide a list of repair shops/dealers/technical information to a user on the basis of information or data inputted to the server 7100.

The upgrade module 7130 may interface with the data processing module 7120. Based on information or data received from the SSD 7200, the upgrade module 7130 may perform upgrades of a firmware, a reset code, a diagnosis system, or other information on electronic appliances.

The scheduling center 7140 may provide real-time options to the user based on the information or data inputted to the server 7100.

The repair information module 7160 may interface with the data processing module 7120. The repair information module 7160 may be used to provide repair-related information (e.g., audio, video or document files) to the user. The data processing module 7120 may package information related to the information received from the SSD 7200. The packaged information may be transmitted to the SSD 7200 or may be displayed to the user.

A non-volatile memory device according to an exemplary embodiment of the inventive concept is applicable to a Perfect Page New (PPN) device.

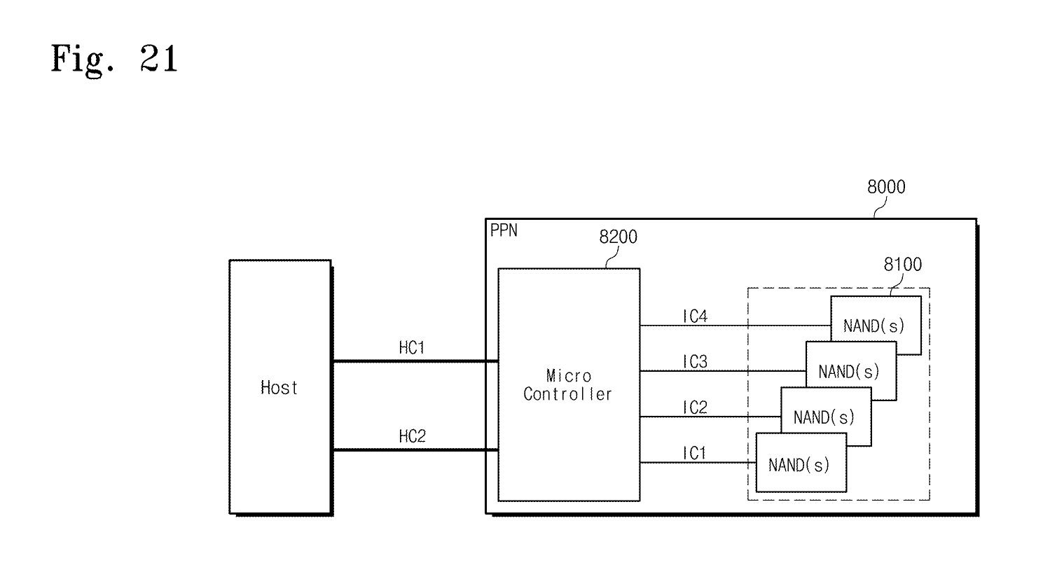

FIG. 21 is a block diagram illustrating a PPN device according to an embodiment of the inventive concept. Referring to FIG. 21, a PPN device 8000 may include a plurality of NAND flash memories 8100 and a controller 8200 for controlling the plurality of NAND flash memories 8100. The PPN device 8000 may be implemented the same as a memory system 10 in FIG. 1.

The PPN device 8000 may communicate with a host via the PPN protocol having a DDR (double data rate) interface. Data communication between the PPN device 8000 and the host may be made via first and second host channels HC1 and HC2. Herein, the number of host channels is not limited to 2. The PPN device 8000 may guarantee the reliability of data such that the host does not include an ECC engine. For example, the PPN device 8000 may guarantee 3000 program/erase cycles over three years.

Data communication between the NAND flash memories 8100 and the controller 8200 may be made via the inner channels IC1 to IC4. Herein, the number of inner channels is not limited to 4.

A memory system according to an exemplary embodiment of the inventive concept may be applicable to a tablet product (e.g., Galaxy S, iPad, etc.).

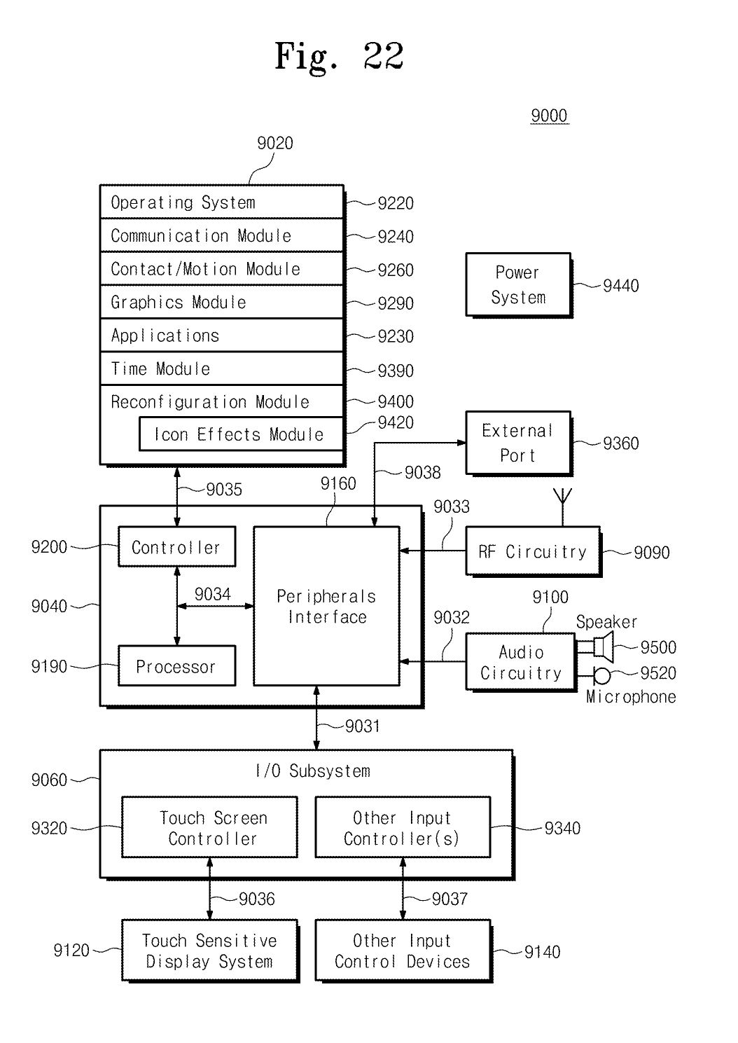

FIG. 22 is a diagram showing a handheld electronic device according to an embodiment of the inventive concept. Referring to FIG. 22, a handheld electronic device 9000 may include at least one computer-readable media 9020, a processing system 9040, an input/output sub-system 9060, a radio frequency circuit 9080, and an audio circuit 9100. Respective constituent elements can be interconnected by at least one communication bus or a signal line 9030.

The handheld electronic device 9000 may be any handheld electronic device including a handheld computer, a tablet computer, a mobile phone, a media player, a PDA, or a combination of at least two elements thereof. Herein, the at least one computer-readable media 8020 may include a memory system 10 in FIG. 1. A more detailed description of one possible version of the handheld electronic device 8000 is provided in U.S. Pat. No. 7,509,588, the subject matter of which is hereby incorporated by reference.

A memory system or a storage device according to various embodiments of the inventive concept may be mounted in various types of packages. Examples of the packages of the memory system or the storage device according to the inventive concept may include Package on Package (PoP), Ball Grid Arrays (BGAs), Chip Scale Packages (CSPs), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), and Wafer-level Processed Stack Package (WSP).

The above-disclosed subject matter is to be considered illustrative, and not restrictive, and the appended claims are intended to cover all such modifications, enhancements, and other embodiments, which fall within the scope of the following claims. Thus, to the maximum extent allowed by law, the scope of the subject inventive concept should be determined by the broadest permissible interpretation of the following claims and their equivalents, and should not be restricted or limited to only the foregoing embodiments.

What is claimed is:

1. A bad block management method for a nonvolatile memory device of a storage device, wherein the nonvolatile memory device includes a plurality of blocks, each of the plurality of blocks being a plurality of strings connected between a bit line and a common source line, each of the plurality of strings including a plurality of memory cells connected in a series, each of the plurality of memory cells being connected to word lines stacked in a direction perpendicular to a substrate, wherein the each of the plurality of blocks includes a plurality of block units, the method comprising:
determining whether at least one block unit of a first block is a bad block unit; and
replacing the at least one block unit of the first block with at least one block unit of a second block, if the at least one block unit of the first block is the bad block unit,
wherein the second block includes at least one block unit used for replacing with a block unit of a third block,
wherein the third block is different the second block.

2. The method of claim 1, wherein the determining is performed in an erase operation.

3. The method of claim 2, wherein the erase operation is performed by block basis.

4. The method of claim 2, wherein the erase operation is performed by block basis.

5. The method of claim 1, wherein each of the plurality of block units is again formed by stacking at least one ground selection line, a plurality of word lines, and at least one string selection line between word line cuts.

6. The method of claim 1, wherein each of the plurality of block units is again formed by stacking at least one ground selection line, a plurality of word lines, and at least one string selection line between a word line cut and a string selection line cut.

7. The method of claim 1, wherein each of the plurality of block units is divided by at least one among a plurality of string selection lines connected to a bit line.

8. The method of claim 1, wherein each of the plurality of block units is divided by at least two among the word lines.

9. The method of claim 1, further comprising assigning the first block as a bad block when all block units of the first block are bad block units.

10. The method of claim 9, further comprising replacing the first block with a reserved block when the first block is the bad block.

11. The method of claim 1, further comprising copying at least one valid block unit of the first block to the third block,
wherein the at least one valid block unit stores valid data.

12. The method of claim 11, wherein the copying the at least one valid block unit includes copying at least one valid block unit of the second block to the third block.

13. The method of claim 12, further comprising erasing the first block after the copying the at least one valid block unit.

14. A storage device comprising:
at least one nonvolatile memory device including a plurality of blocks having a plurality of strings connected between a memory cell array including a plurality of memory blocks having a plurality of strings connected to a bit line, each of the plurality of strings including a plurality of memory cells connected in a series, each the plurality of memory cells being connected word lines stacked in a direction perpendicular to a substrate, wherein the each of the plurality of blocks includes a plurality of block units; and
a memory controller configured to control the at least one nonvolatile memory device;
wherein the memory controller determines whether at least one block unit of a first block is a bad block unit, and replaces the at least one block unit of the first block with at least one block unit of a second block, if the at least one block unit of the first block is the bad block unit,
wherein the second block includes at least one block unit used for replacing with a block unit of a third block,
wherein the third block is different the second block.

15. The storage device of claim 14, wherein the memory controller assigns the first block as a bad block when all block units of the first block are bad block units.

16. The storage device of claim 15, wherein the memory controller replaces the first block with a reserved block when the first block is the bad block, copies at least one valid block unit of the first block to a third block, and copies the at least one valid block unit includes copying at least one valid block unit of the second block to the third block.

17. The storage device of claim 16, the memory controller erases the first block after the copying the at least one valid block unit.

18. The storage device of claim 14, the memory controller comprises a host interface configured to perform a serial interface with a host.

19. A nonvolatile memory device comprising:
a memory cell array including a plurality of blocks having a plurality of strings connected between a bit line, each of the plurality of strings including a plurality of memory cells connected in a series, each the plurality of memory cells being connected word lines stacked in a direction perpendicular to a substrate, wherein the each of the plurality of blocks includes a plurality of block units;
an address decoder configured to select one of the plurality of blocks based upon an address; and
a control logic configured to control the address decoder and the voltage generation circuit at a program operation, a read operation, or an erase operation;
wherein at least one of the plurality of blocks is used a reserved block for replacing at least one block unit of a first block with at least one block unit of the reserved block, if the at least one block unit of the first block is the bad block unit,
wherein the second block includes at least one block unit used for replacing with a block unit of a third block.

20. The nonvolatile memory device of claim 19, wherein the erase operation is performed by block unit basis.
